(19) United States
(12) Patent Application Publication
(10) Pub. No.: US 2013/0163146 A1
(43) Pub. Date: Jun. 27, 2013

(54) ELECTRODE ACTIVE MATERIAL-CONDUCTIVE AGENT COMPOSITE, METHOD FOR PREPARING THE SAME, AND ELECTROCHEMICAL CAPACITOR COMPRISING THE SAME

(71) Applicant: SAMSUNG ELECTRO-MECHANICS CO., LTD., Suwon (KR)

(72) Inventors: Sang Kyun LEE, Suwon (KR); Seung Min Kim, Seoul (KR); Bae Kyun Kim, Seongnam (KR)

(73) Assignee: SAMSUNG ELECTRO-MECHANICS CO., LTD., Suwon (KR)

(21) Appl. No.: 13/718,303

(22) Filed: Dec. 18, 2012

(30) Foreign Application Priority Data
Dec. 23, 2011 (KR) 10-2011-0141462

(51) Int. Cl. H01G 11/32

(52) U.S. Cl. CPC H01G 11/32
USPC 361/502; 252/500; 252/502; 428/402

(57) ABSTRACT

The present invention relates to an electrode active material-conductive agent composite including an electrode active material and a conductive agent, a method for preparing the same, an electrochemical capacitor comprising the same.

According to the present invention, it is possible to increase capacity of an electrochemical capacitor by mixing an electrode active material and a conductive agent and spray-drying the mixture to prepare an electrode active material-conductive agent composite with a fine granule shape and including the composite in an electrode active material composition to increase packing density of an electrode active material layer.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2011-0141462, entitled filed Dec. 23, 2011, which is hereby incorporated by reference in its entirety into this application.

### BACKGROUND OF THE INVENTION

1. Field of the Invention

The present invention relates to an electrode active material-conductive agent composite, a method for preparing the same, and an electrochemical capacitor comprising the same.

2. Description of the Related Art

An electric double layer capacitor (EDLC) is a field that has been successively developed in connection with recent environmental issues since it has excellent input/output characteristics and high cycle reliability compared to secondary batteries such as lithium ion secondary batteries. For example, the EDLC is promising as a main power supply and an auxiliary power supply of electric vehicles or a power storage device of renewable energy such as solar power and wind power.

Further, it is expected that the EDLC will be utilized as a device, which can extract high current in a short time, in an uninterruptible power supply in great demand according to IT trends.

This EDLC has a structure in which a pair or plurality of polarizable electrodes (cathode and anode) mainly made of a carbon material are immersed in an electrolytic solution to face each other with a separator interposed therebetween and uses a principle that charges are accumulated on an electric double layer formed on the interface between the polarizable electrodes and the electrolytic solution at this time.

An operation principle and a basic structure of the EDLC are as shown in FIG. 1. Referring to this, the EDLC consists of a current collector 10, an electrode 20, an electrolytic solution 30, and a separator 40.

The electrode 20 consists of a carbon active material with a large effective specific surface area such as activated carbon powder or activated carbon fibers, a conductive agent for giving conductivity, and a binder for adhesion between components. Further, the electrode 20 consists of a cathode 21 and an anode 22 with the separator 40 interposed therebetween.

Further, the electrolytic solution 30 is an aqueous electrolytic solution or a non-aqueous (organic) electrolytic solution.

The separator 40 is polypropylene or Teflon and plays a role of preventing a short due to contact between the cathode 21 and the anode 22.

The EDLC uses a principle that electrolytic ions 31 a and 31 b dissociated on surfaces of the respective cathode 21 and anode 22 are physically adsorbed on the opposite electrode to accumulate electricity when a voltage is applied during charging and the ions of the cathode 21 and the anode 22 are desorbed from the electrodes to be returned to a neutralized state during discharging.

In general, since an active material, which is used as a main material of an electrochemical capacitor, is advantageous to generation of electrons on the interface using a wide specific surface area but relatively disadvantageous in conductivity, a conductive agent with a size of nm is added to implement required characteristics. However, although the amount of the conductive agent is increased in general processes, it is not possible to implement desired low resistance characteristics. This is because uniform mixing of the active material and the conductive agent is not implemented due to dispersion and structural characteristics of the particulate conductive agent.

In case of a typical electrochemical capacitor, capacity is implemented by expression of electrons due to adsorption and desorption of electrolytic ions on a surface of activated carbon. FIG. 2 shows a schematic diagram of the electrode 20 of the electrochemical capacitor. The electrode 20 is formed by applying an electrode active material layer, which consists of a carbon active material 51 with a large effective specific surface area, a conductive agent 52 for giving conductivity, and a binder 53 for adhesion between components, on the current collector 10. The electrons 60 expressed by the adsorption and desorption of the ions, as in FIG. 2, flow along the conductive agent 52. In general, electrons flow along a path with the lowest resistance, and it is natural that the electrons 60 flow along the conductive agent 52 (arrow direction) since specific resistance of the conductive agent 52 is lower than that of the active material 51 by about two orders.

Further, generally, since an active material, which is used as a main material of the electrochemical capacitor, is advantageous to generation of electrons on the interface using a wide specific surface area but relatively disadvantageous in conductivity, a conductive agent with a size of nm is added to implement required characteristics. However, although the amount of the conductive agent is increased in general processes, it is not possible to implement desired low resistance characteristics. This is because uniform mixing of the active material and the conductive agent is not implemented due to dispersion and structural characteristics of the particulate conductive agent.

That is, generally, the active material 51, which mainly affects the expressions of the electrons, has a size of several pm as in FIG. 3, and a particle diameter of the conductive agent 52, which is a moving path of the electrons, corresponds to several pm as in FIG. 4. Therefore, it is difficult to expect the uniform mixing of the active material and the conductive agent in the electrode due to a difference in particle size between the active material and the conductive agent.

Actually, agglomeration of the conductive agent occurs, and generally, segregation of particles due to the difference in particle size between the active material and the conductive agent occurs as in FIG. 5. Therefore, a gap between the particles may occur. Due to this, resistance characteristics of the product may be deteriorated, thus causing degradation of reliability of the electrochemical capacitor.

### SUMMARY OF THE INVENTION

The present invention has been invented in order to overcome the above-described problems and it is, therefore, an object of the present invention to provide an electrode active material-conductive agent composite comprising an electrode active material and a conductive agent with a spherical granule shape to improve dispersibility of the active material and the conductive agent.

Further, it is another object of the present invention to provide a method for preparing an electrode active material-conductive agent composite.

It is still another object of the present invention to provide an electrochemical capacitor comprising an electrode active material-conductive agent composite.

In accordance with one aspect of the present invention to achieve the object, there is provided an electrode active material-conductive agent composite characterized by including an electrode active material and a conductive agent.

The electrode active material-conductive agent composite may have a particle size of 10 to 70 μm.

The electrode active material-conductive agent composite may have a spherical granule shape.

It is preferred that the electrode active material is at least one carbon material selected from the group consisting of carbon nanotube (CNT), graphite, carbon aerogel, polyacrylonitrile (PAN), carbon nanofiber (CNF), activated carbon nanofiber (ACNF), vapor grown carbon fiber (VGCF), and graphene.

It is most preferred that the electrode active material is activated carbon with a specific surface area of 1,500 to 3,000 m²/g.

It is preferred that the conductive agent is at least one conductive carbon selected from the group consisting of super-P, acetylene black, carbon black, and Ketjen black.

The electrode active material and the conductive agent may be included in the electrode active material-conductive agent composite at a weight ratio of 10:1 to 10:2.5.

The electrode active material-conductive agent composite may be prepared by spray-drying a mixture of the electrode active material and the conductive agent.

The mixture of the electrode active material and the conductive agent may further include a binder and a solvent.

In accordance with another aspect of the present invention to achieve the object, there is provided a method for preparing an electrode active material-conductive agent composite including the steps of: preparing a mixture of an electrode active material and a conductive agent; and spray-drying the mixture of the electrode active material and the conductive agent.

The electrode active material and the conductive agent may be included in the mixture of the electrode active material and the conductive agent at a weight ratio of 10:1 to 10:2.5.

Further, in accordance with still another aspect of the present invention to achieve the object, there is provided an electrochemical capacitor comprising an electrode active material-conductive agent composite.

The electrode active material-conductive agent composite may be used in one or both of a cathode and an anode.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 shows a basic structure and an operation principle of a typical electric double layer capacitor;

FIG. 2 is a schematic diagram of an electrode of an electrochemical capacitor;

FIG. 3 is a scanning electron microscope photograph showing particle size and shape of an active material;

FIG. 4 is a scanning electron microscope photograph showing particle size and shape of a conductive agent;

FIG. 5 is a scanning electron microscope photograph showing types of pores existing in the electrode of the electrochemical capacitor and the enlarged pores;

FIG. 6 is a scanning electron microscope photograph showing a shape of dried powder prepared according to a comparative example; and

FIG. 7 is a scanning electron microscope photograph showing a shape of electrode active material-conductive agent composite powder spray-dried according to an embodiment.

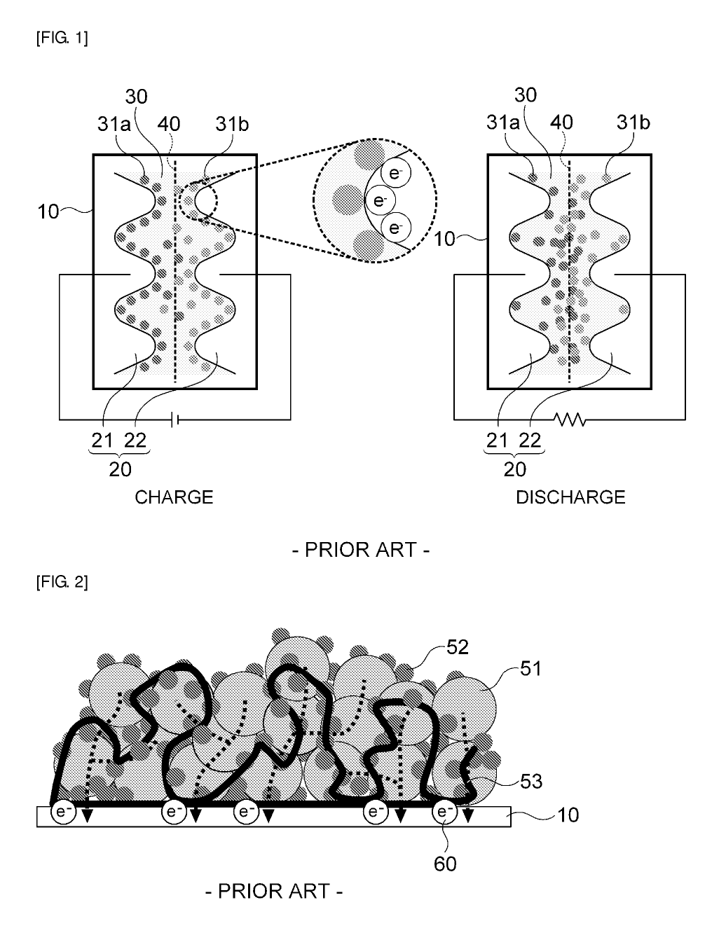

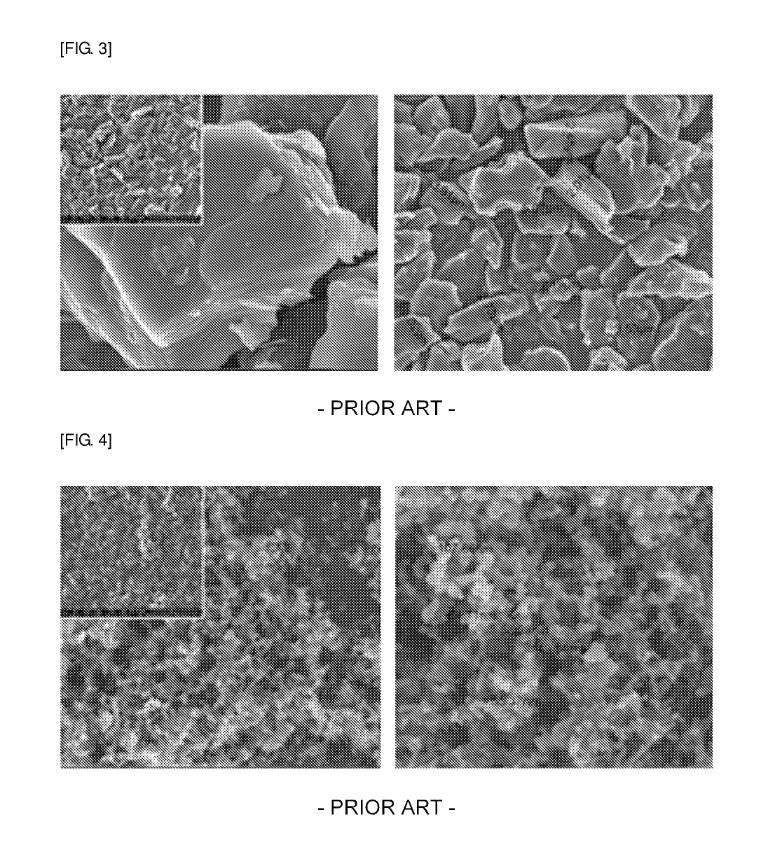

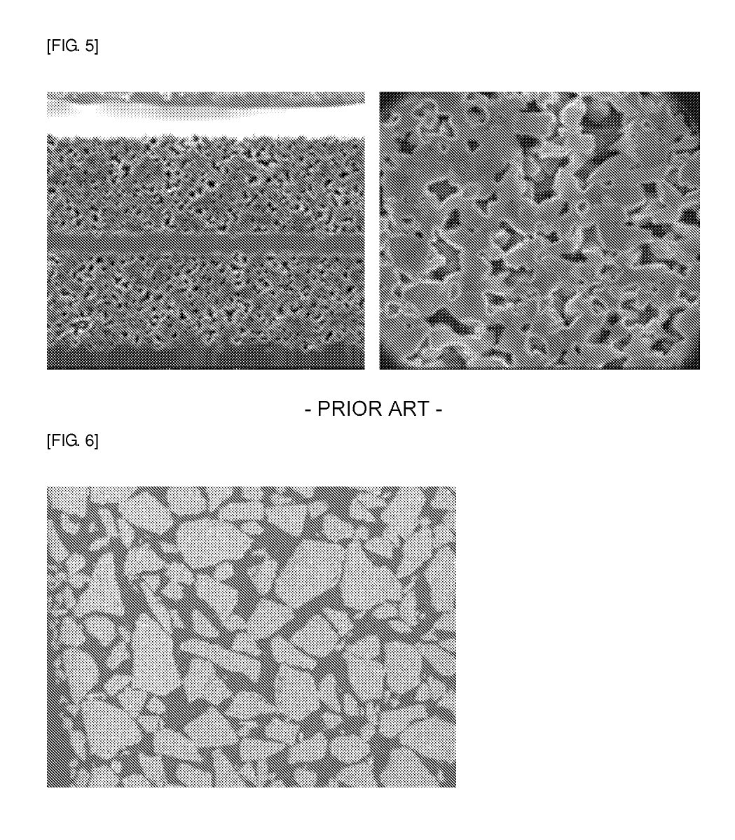

### DETAILED DESCRIPTION OF THE PREFERABLE EMBODIMENTS

Hereinafter, the present invention will be described in detail.

Terms used herein are provided to explain embodiments, not limiting the present invention. Throughout this specification, the singular form includes the plural form unless the context clearly indicates otherwise. Further, terms “comprises” and/or “comprising” used herein specify the existence of described shapes, numbers, steps, operations, members, elements, and/or groups thereof, but do not preclude the existence or addition of one or more other shapes, numbers, operations, members, elements, and/or groups thereof.

The present invention relates to an electrode active material-conductive agent composite, a method for preparing the same, and an electrochemical capacitor comprising the same that are capable of improving dispersibility of an electrode active material composition by preparing an electrode active material and a conductive agent in the form of a composite and including the composite in the electrode active material composition.

In order to overcome deterioration of dispersibility and separation of particles in the electrode active material composition due to a difference in particle size between the electrode active material and the conductive agent, the present invention mixes the electrode active material and the conductive agent to prepare an electrode active material-conductive agent composite and includes the composite in the electrode active material composition.

An electrode active material-conductive agent composite in accordance with the present invention is prepared through the steps of preparing a mixture of an electrode active material and a conductive agent and spray-drying the mixture of the electrode active material and the conductive agent.

It is preferred that the electrode active material of the present invention is at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor grown carbon fiber (VGCF), and graphene with a particle size of 5 to 30 μm. Among them, activated carbon with a specific surface area of 1,500 to 3,000 m²/g is the most preferable.

Further, preferably, the conductive agent is at least one conductive carbon selected from the group consisting of super-P, acetylene black, carbon black, and Ketjen black.

In terms of implementation of low resistance and high capacity products, it is preferred that the electrode active material and the conductive agent are included at a weight ratio of 10:1 to 10:2.5.

Further, the mixture of the electrode active material and the conductive agent may include a binder and a solvent. That is, the electrode active material-conductive agent composite may be prepared by mixing the electrode active material, the conductive agent, and the solvent and spray-drying the mixture to volatilize only the solvent or by adding a small amount of dispersant.

For example, the dispersant may be at least one selected from fluorine resins such as polytetrafluoroethylene (PTFE) and polyvinylidenfluoride (PVDF); thermoplastic resins such as polyimide, polyamideimide, polyethylene (PE), and polypropylene (PP); cellulose resins such as carboxymethyl cellulose (CMC); rubber resins such as styrene-butadiene rubber (SBR); and mixtures thereof but not particularly limited thereto, and all binder resins used in the typical electrochemical capacitors can be used as the dispersant.

Further, the type of solvent is not particularly limited if the solvent can be used in the active material composition of the electrochemical capacitor.

When spray-drying the mixture of the electrode active material, the conductive agent, and so on, it is possible to obtain the electrode active material-conductive agent composite with a spherical granule shape of the most stable structure by adsorbing the conductive agent with a relatively small particle size around the electrode active material with a relatively large particle size.

The electrode active material-conductive agent composite may have a particle size of 10 to 70 μm, and the size of the composite may be appropriately adjusted according to concentration and viscosity of the mixture. It is preferred that the viscosity of the mixture is less than 500 cps in a rest state in preparing the spherical granule electrode active material-conductive agent composite with an appropriate particle size. The lower the viscosity of the mixture is, the more it is advantageous to preparation of the electrode active material-conductive agent composite granules with a small particle size.

The rest state of the present invention means a state in which the mixture of the electrode active material and the conductive agent is left as it is without application of any external shear, and the viscosity in the present invention is measured in the above state.

Further, in order to obtain an agglomerate with homogeneous composition, it is preferable to perform spray-drying of the mixture of the electrode active material and the conductive agent in a condition in which the active material and the conductive agent are relatively uniformly mixed. For example, the electrode active material and the conductive agent in a liquid state may be dispersed by equipment such as a planetary dispersive mixer, a microfludizer, an apex mill, and a clear mixer.

In a prior art, there was a problem of separation of particles due to a difference in particle size between an electrode active material and a conductive agent, but in the present invention, the electrode active material and the conductive agent form the composite and have an agglomerate structure.

Further, since the electrode active material-conductive agent composite exists in the most stable spherical shape without existing in the form of irregular particles, it is possible to improve packing density.

Further, the present invention is characterized by providing an electrochemical capacitor comprising an electrode active material-conductive agent composite.

The electrode active material-conductive agent composite can be used in one or both of a cathode and an anode.

That is, the final electrochemical capacitor can be manufactured by insulating a cathode, which is formed by applying an electrode active material composition comprising the prepared electrode active material-conductive agent composite on a cathode current collector, and an anode, which is formed by applying the electrode active material composition comprising the prepared electrode active material-conductive agent composite on an anode current collector, through a separator and immersing the cathode and the anode in an electrolytic solution to be sealed.

In addition to the electrode active material-conductive agent composite, the electrode active material composition may separately include a conductive agent, a binder, and a solvent.

The conductive agent, the binder, and the solvent may be the same as those used in preparation of the electrode active material and the conductive agent composite.

In the present invention, a mixture of the electrode active material-conductive agent composite, the conductive agent, and the solvent may be formed into a sheet by the binder resin or a sheet extruded by extrusion may be bonded to the current collector by a conductive adhesive.

The cathode current collector in accordance with the present invention may be made of materials used in conventional electric double layer capacitors and lithium ion batteries, for example, at least one selected from the group consisting of aluminum, stainless steel, titanium, tantalum, and niobium. Among them, aluminum is preferable.

It is preferred that a thickness of the cathode current collector is 10 to 300 μm. In addition to the above metal foils, etched metal foils or materials such as expanded metal, punched metal, nets, and foam having holes penetrating front and rear surfaces can be used as the current collector.

Further, the anode current collector in accordance with the present invention may be made of all materials used in the conventional electric double layer capacitors and lithium ion batteries, for example, stainless steel, copper, nickel, and alloys thereof. Among them, copper is preferable. Further, it is preferred that a thickness of the anode current collector is 10 to 300 μm. In addition to the above metal foils, etched metal foils or materials such as expanded metal, punched metal, nets, and foam having holes penetrating front and rear surfaces can be used as the current collector.

The separator in accordance with the present invention may use all materials used in the conventional electric double layer capacitors or lithium ion batteries, for example, a microporous film manufactured from at least one polymer selected from the group consisting of polyethylene (PE), polypropylene (PP), polyvinylidenfluoride (PVDF), polyvinylidene chloride, polyacrynitrile (PAN), polyacrylamide (PAAm), polytetrafluoroethylene (PTFE), polysulfone, polyether sulfone (PES), polycarbonate (PC), polyamide (PA), polyimide (PI), polyethyleneoxide (PEO), polypropylene oxide (PPO), cellulose polymers, and polyacrylic polymers. Further, a multilayer film manufactured by polymerizing the porous film may be used, and among them, cellulose polymers may be preferably used.

It is preferred that a thickness of the separator is about 15 to 35 μm but not limited thereto.

The electrolytic solution of the present invention may be organic electrolytic solutions containing non-lithium salts such as spiro salts, TEABF₄, and TEMABF₄ or lithium salts such as LiPF₆, LiBF₄, LiCLO₄, LiN(CF₃SO₂)₂, CF₃SO₃Li, LiC(SO₂CF₃)₃, LiAsF₆, and LiSbF₆ or mixtures thereof. The solvent may be at least one selected from the group consisting of acrylonitrile, ethylene carbonate, propylene carbonate, dimethyl carbonate, ethyl methyl carbonate, sulfolane, and dimethoxyethane but not limited thereto. The electrolytic solution, in which these solute and solvent are mixed, has a high withstand voltage and high electrical conductivity. It is preferred that concentration of an electrolyte in the electrolytic solution is 0.1 to 2.5 mol/L, particularly 0.5 to 2.0 mol/L.

It is preferred that a case (exterior material) of the electrochemical capacitor of the present invention uses an aluminum-containing laminate film, which is typically used in the secondary batteries and the electric double layer capacitors, but not particularly limited thereto.

Hereinafter, preferred embodiments of the present invention will be described in detail. The following embodiments merely illustrate the present invention, and it should not be interpreted that the scope of the present invention is limited to the following embodiments. Further, although certain compounds are used in the following embodiments, it is apparent to those skilled in the art that equal or similar effects are shown even when using their equivalents.

### Embodiment 1

Activated carbon (specific surface area 2000 m²/g) with a size of 10 μm 160 g, super-P with a particle size of 50 nm 20 g, CMC 5 g as a dispersant, and water 2500 g as a solvent are mixed and stirred. A spherical electrode active material-conductive agent composite with a size of 30 μm is prepared by spray-drying the mixture (viscosity 450 cps in rest state) in a heating chamber.

### Embodiment 2

An electrode active material slurry composition is prepared by mixing and stirring the electrode active material-conductive agent composite 100 g prepared in the embodiment 1, Ketjen black 5 g as a conductive agent, CMC 3.5 g, SBR 12.0 g, and PTFE 5.5 g as binder resins, and water 225 g.

The electrode active material slurry composition is applied on an etched aluminum foil with a thickness of 20 μm by a comma coater, temporarily dried, and cut to an electrode size of 50 mm×100 mm. A cross-sectional thickness of the electrode is 60 μm. Before assembly of a cell, the electrode is dried in a vacuum at 120° C. for 48 hours.

An electrochemical capacitor is manufactured by inserting a separator (TF4035 from NKK, cellulose separator) between the prepared electrodes (cathode, anode), immersing the electrodes in an electrolytic solution (acrylonitrile solvent, concentration of spiro salts 1.3 mol/L), and putting the electrodes in a laminate film case to be sealed.

### Comparative Example 1

A mixture is prepared by mixing and stirring activated carbon (specific surface area 2000 m²/g) with a size 10 μm 160 g, super-P with a particle size of 50 nm 25 g, CMC 8.5 g as a dispersant, and water 500 g as a solvent. An electrode active material-conductive agent composite is prepared by coating the mixture with a comma roll coater, drying the mixture, and roll-pressing the mixture. A thickness of an electrode after roll-pressing is 60 μm.

### Comparative Example 2

An electrochemical capacitor is manufactured by the same process as the embodiment 2 except that the electrode active material-conductive agent composite prepared in the comparative example 1 is used.

### Experimental Example 1: Shape Comparison of Electrode Active Material-Conductive Agent Composites

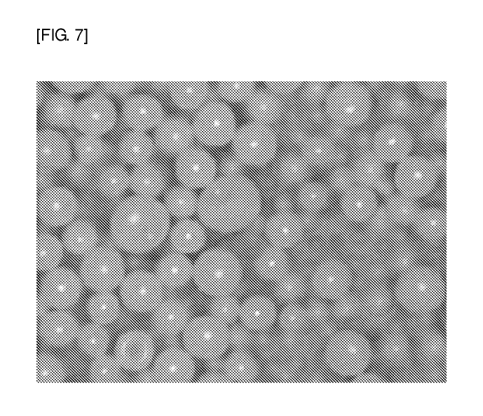

Shapes of the electrode active material-conductive agent composites prepared according to the comparative example 1 and the embodiment 1 are measured by a scanning electron microscope, and measurement results are shown in FIGS. 6 and 7, respectively.

In case of FIG. 6 in which a general drying process is performed like the prior art, it is possible to check that separation between particles occurs due to differences in particle size and density between an active material and a conductive agent and further the size and shape of the particles are very irregular. In case of this structure, even though the electrode active material is applied, since the particles cannot be uniformly packed, capacity of the electrode is reduced.

However, in case of FIG. 7 in which the electrode active material-conductive agent composition is formed like the present invention, it is possible to check that the particles of the electrode active material and the conductive agent have a granular shape, which can be relatively easily packed, as well as a composite shape agglomerated with each other. Therefore, when including the electrode active material-conductive agent composite as an electrode active material, it is possible to contribute to an increase in the capacity of the electrode by improving packing density.

### Experimental Example; Estimation of Resistance and Capacity of Electrochemical Capacitor Cell

Initial resistance (measured by AC meter) of the electrochemical capacitor cells manufactured according to the comparative example 2 and the embodiment 2 is measured, and in case of capacity, discharge capacity of the fifth cycle is measured by charging the cells to 2.8V at a constant current and discharging the cells to 2.0V at a constant current. Measurement results are shown in the following table 1.

TABLE 1

| | | Comparative |
|---|---|---|
| Classification | Embodiment 2 | Example 2 |
| AC resistance (mW) | 9.2 | 14.2 |
| Capacity (F) | 20.1 | 15.3 |

As in the results of the table 1, it is possible to check that the electrochemical capacitor (embodiment 2) comprising the electrode active material-conductive agent composite prepared according to the embodiment 1 of the present invention has low resistance and high capacity compared to the electrochemical capacitor comprising the electrode active material-conductive agent composite of the comparative example 1 prepared according to the conventional method.

According to the present invention, it is possible to increase capacity of an electrochemical capacitor by mixing an electrode active material and a conductive agent and spray-drying the mixture to prepare an electrode active material-conductive agent composite with a fine granule shape and including the composite in an electrode active material composition to increase packing density of an electrode active material layer.

Therefore, it is possible to manufacture an electrochemical capacitor with high-speed charge and discharge cycle reliability as well as high withstand voltage, energy density, and input/output characteristics.

What is claimed is:

1. An electrode active material-conductive agent composite comprising an electrode active material and a conductive agent.

2. The electrode active material-conductive agent composite according to claim 1, wherein the electrode active material-conductive agent composite has a particle size of 10 to 70 μm.

3. The electrode active material-conductive agent composite according to claim 1, wherein the electrode active material-conductive agent composite has a spherical granule shape.

4. The electrode active material-conductive agent composite according to claim 1, wherein the electrode active material is at least one carbon material selected from the group consisting of carbon nanotube (CNT), graphite, carbon aerogel, polyacrylonitrile (PAN), carbon nanofiber (CNF), activated carbon nanofiber (ACNF), vapor grown carbon fiber (VGCF), and graphene.

5. The electrode active material-conductive agent composite according to claim 1, wherein the electrode active material is activated carbon with a specific surface area of 1,500 to 3,000 m²/g.

6. The electrode active material-conductive agent composite according to claim 1, wherein the conductive agent is at least one conductive carbon selected from the group consisting of super-P, acetylene black, carbon black, and Ketjen black.

7. The electrode active material-conductive agent composite according to claim 1, wherein the electrode active material and the conductive agent are included in the electrode active material-conductive agent composite at a weight ratio of 10:1 to 10:2.5.

8. The electrode active material-conductive agent composite according to claim 1, further comprising a dispersant and a solvent.

9. The electrode active material-conductive agent composite according to claim 8, wherein the dispersant is at least one selected from polytetrafluoroethylene (PTFE), polyvinylidenfluoride (PVDF), polyimide, polyamideimide, polyethylene (PE), polypropylene (PP), carboxymethyl cellulose (CMC), styrene-butadiene rubber (SBR), acrylic rubber, and mixtures thereof.

10. A method for preparing an electrode active material-conductive agent composite comprising:
preparing a mixture of an electrode active material and a conductive agent; and
spray-drying the mixture of the electrode active material and the conductive agent.

11. The method for preparing an electrode active material-conductive agent composite according to claim 10, wherein the electrode active material and the conductive agent are included in the mixture of the electrode active material and the conductive agent at a weight ratio of 10:1 to 10:2.5.

12. The method for preparing an electrode active material-conductive agent composite according to claim 10, wherein viscosity of the mixture of the electrode active material and the conductive agent is less than 500 cps in a rest state.

13. An electrochemical capacitor comprising an electrode active material-conductive agent composite according to claim 1.

14. The electrochemical capacitor according to claim 13, wherein the electrode active material-conductive agent composite is included in one or both of a cathode and an anode.
